(19) United States
(12) Patent Application Publication
(10) Pub. No.: US 2014/0093756 A1
(43) Pub. Date: Apr. 3, 2014

(54) ASSEMBLED BATTERY

(71) Applicant: Lithium Energy Japan, Kyoto-shi (JP)

(72) Inventors: Seiji Nemoto, Ritto-shi (JP); Toshiki Kusunoki, Ritto-shi (JP)

(73) Assignee: Lithium Energy Japan, Kyoto-shi (JP)

(21) Appl. No.: 14/039,244

(22) Filed: Sep. 27, 2013

(30) Foreign Application Priority Data
Sep. 28, 2012 (JP) 2012-218469

(51) Int. Cl. H01M 2/04

(52) U.S. Cl. CPC H01M 2/0482; H01M 2/043
USPC 429/53; 429/156

(57) ABSTRACT

An assembled battery includes plural electric cells, a covered member at least a portion of which is made of metal, and insulation cover. The covered member is disposed along side portions of the electric cells on which terminals are provided. The insulation cover includes a main portion interposed between the covered member and the side portions of the electric cells, and an auxiliary portion extending from the main portion along a projecting direction of the terminal.

### CROSS-REFERENCE TO RELATED APPLICATIONS

This application claims priority of Japanese Patent Application No.: 2012-218469 filed on Sep. 28, 2012, the content of which is incorporated herein by reference.

### FIELD

The present invention relates to an assembled battery (battery module) in which plural electric cells (battery cells) are electrically connected to each other so as to be modularized.

### BACKGROUND

An in-vehicle assembled battery disclosed in JP 2011-100699 A includes electric cells each of which includes a gas exhaust valve which opens if an internal pressure is raised equal to or more than a predetermined pressure and an exhaust duct through which gas discharged from the gas exhaust valve is conducted to outside.

If a metal exhaust duct comes into contact with a terminal of an electric cell, this may cause short circuit. Especially when an assembled battery is an in-vehicle battery provided in a vehicle such as an electric car, it is necessary to reliably avoid contact between the exhaust duct and the terminal of the electric cell which may be caused by vibration or impact. However, in the conventional assembled batteries including that described in JP 2011-100699 A, enough consideration is not paid for preventing the contact between the exhaust duct and the terminal of the electric cell. Further, enough consideration is not paid for preventing the contact between the terminal of the electric cell and metal members other than the exhaust duct (e.g., metal beam member for connecting a pair of side plates (end plates) constituting a casing of the assembled battery).

### SUMMARY

The following presents a simplified summary of the invention disclosed herein in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

It is an object of the present invention to prevent short circuit caused by contact between a terminal of an electric cell constituting an assembled battery and a member at least partially made of metal.

An aspect of the present invention provides an assembled battery, comprising, plural electric cells, a covered member disposed along side portions of the electric cells on which terminals of the electric cells are provided, at least a portion of the covered member being made of metal, and an insulation cover including a main portion interposed between the covered member and the side portions of the electric cells and an auxiliary portion extending from the main portion along a projecting direction of the terminal.

### BRIEF DESCRIPTION OF DRAWINGS

The foregoing and the other features of the present invention will become apparent from the following description and drawings of an illustrative embodiment of the invention in which:

FIG. 1 is an exploded perspective view of an assembled battery according to an embodiment of the present invention;

FIG. 2 is a perspective view of the assembled battery according to the embodiment of the invention;

FIG. 3 is an exploded perspective view of the assembled battery according to the embodiment of the invention;

FIG. 4 is an exploded perspective view of a duct;

FIG. 5 is an exploded perspective view of the duct as viewed from a side opposite from FIG. 4;

FIG. 6 is a schematic sectional view taken along a line VI-VI in FIG. 2; and

FIG. 7 is a schematic sectional view similar to FIG. 6 showing a modification of a duct cover.

### DESCRIPTION OF EMBODIMENTS

An aspect of the present disclosure provides an assembled battery comprising plural electric cells, a covered member disposed along side portions of the electric cells on which terminals of the electric cells are provided, at least a portion of the covered member being made of metal, and an insulation cover including a main portion interposed between the covered member and the side portions of the electric cells and an auxiliary portion extending from the main portion along a projecting direction of the terminal.

By the auxiliary portion of the insulation cover extending along the projecting direction of the terminal of the electric cell, the covered member can be reliably prevented from coming into contact with the terminal of the electric cell. Therefore, it is possible to reliably prevent short circuit between the terminals of the electric cells which may be caused by the contacts between the covered member and the terminals. For example, even when the covered member approaches the terminal of the electric cell due to vibration or impact, the auxiliary portion of the insulation cover is interposed between the covered member and the terminal. The interposed auxiliary portion prevents the covered member from coming into contact with the terminal. Even when the assembled battery is damaged or broken so that a bus bur for electrically connecting the terminals of the electric cells is disengaged from the terminal and approaches the covered member, the auxiliary portion of the insulation cover is interposed between the covered member and the bus bar disengaged from the terminal. The interposed auxiliary portion avoids contact between the covered member and the bus bar disengaged from the terminal (indirect contact between covered member and terminal through the bus bar).

Specifically, the plural electric cells are arranged with such postures that the side portions of the electric cells on which the terminals are provided extend in a vertical direction. the covered member and the insulation cover are disposed so as to extend in an arranged direction of the electric cells along the side portions of the electric cells. More specifically, positions of the covered member and the insulation cover in a vertical direction are set at an intermediate position of a pair of the terminals of each of the electric cells.

When the covered member is disposed with respect to the electric cell with such posture and position, the covered member tends to approach the terminal and the bus bar disengaged from the terminal tends to approach the covered member due to vibration or impact. Therefore, in this case, a contact-preventing function between the covered member and the terminal obtained by providing the insulation cover is especially effective.

Preferably, a height of the auxiliary portion of the insulation cover with respect to the side portion of the electric cell is equal to or higher than a height of the terminal with respect to the side portion of the electric cell.

By setting the height of the auxiliary portion of the insulation cover is set sufficiently high relative to the height of the terminal, it is possible to more reliably prevent the covered member from coming into contact with the terminal of the electric cell and to more reliably prevent short circuit which may be caused by the contact.

The assembled battery may further include a frame member which is interposed between the side portions of the electric cells and the insulation cover and which includes a surrounding wall surrounding the terminal.

In addition to the auxiliary portion of the insulation cover, the surrounding wall of the frame member is also interposed between the terminal and the covered member. Hence, the covered member can be more reliably prevented from coming into contact with the terminal and to more reliably prevent short circuit which may be caused by the contact.

Preferably, a height of the surrounding wall of the frame member with respect to the side portion of the electric cell is equal to or higher than a height of the terminal with respect to the side portion of the electric cell.

Specifically, the insulation cover is made of material with insulation property.

For example, the covered member is an exhaust duct through which gas discharged from the electric cell is conducted outside. Specifically, the electric cells respectively include gas exhaust portions provided in the side portions on which the terminals are provided, the gas exhaust portions opening when an internal pressure reaches equal to or more than a predetermined value so as to discharge gas. The exhaust duct includes gas inlets provided at positions opposed to the gas exhaust portions of the electric cells. A seal member for air-tightly connecting the gas exhaust portion and the gas inlet is interposed between the exhaust duct and the electric cell.

By the auxiliary portion of the insulation cover extending along the projecting direction of the terminal of the electric cell, the covered member (e.g., the exhaust duct) can be prevented from coming into contact with the terminals of the electric cells, thereby preventing contact between the terminals due to the contact between the covered member and the terminal.

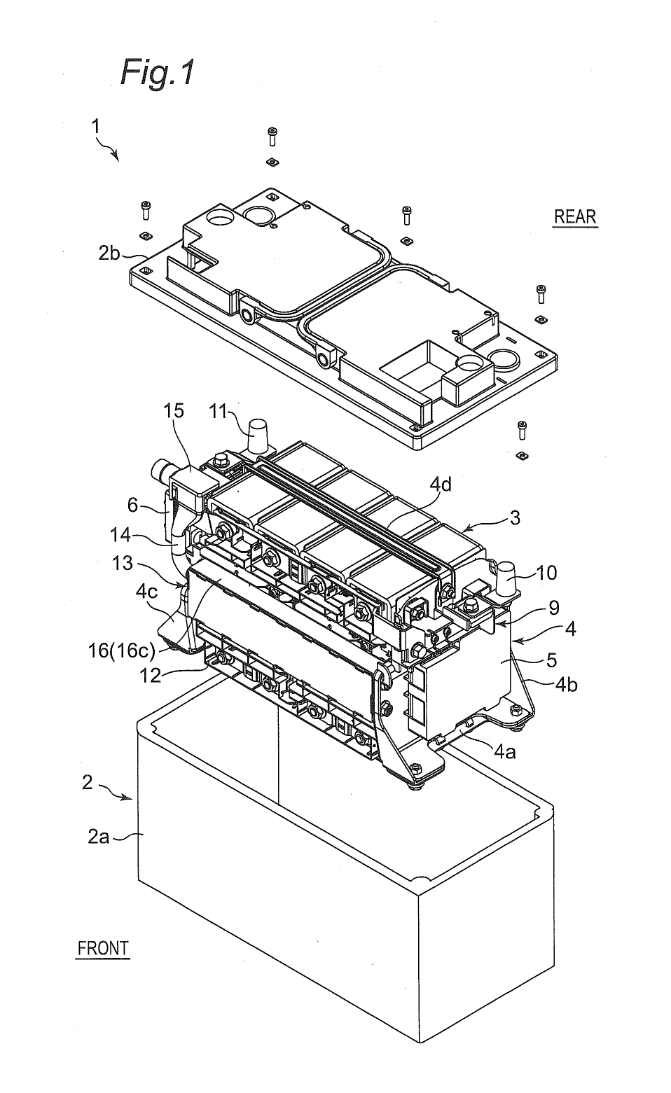

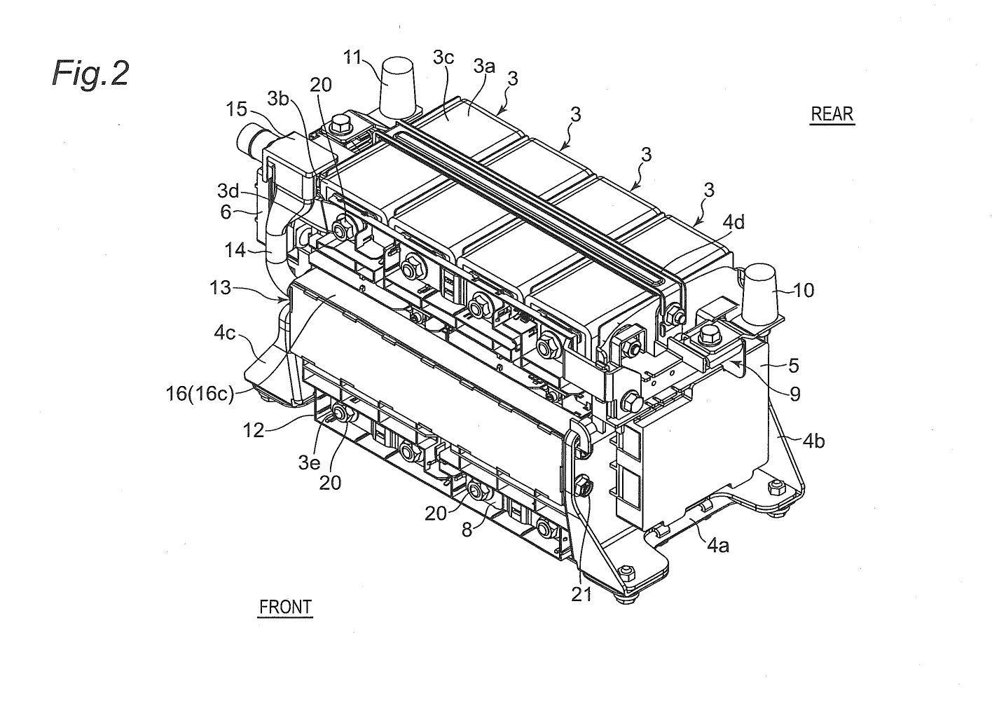

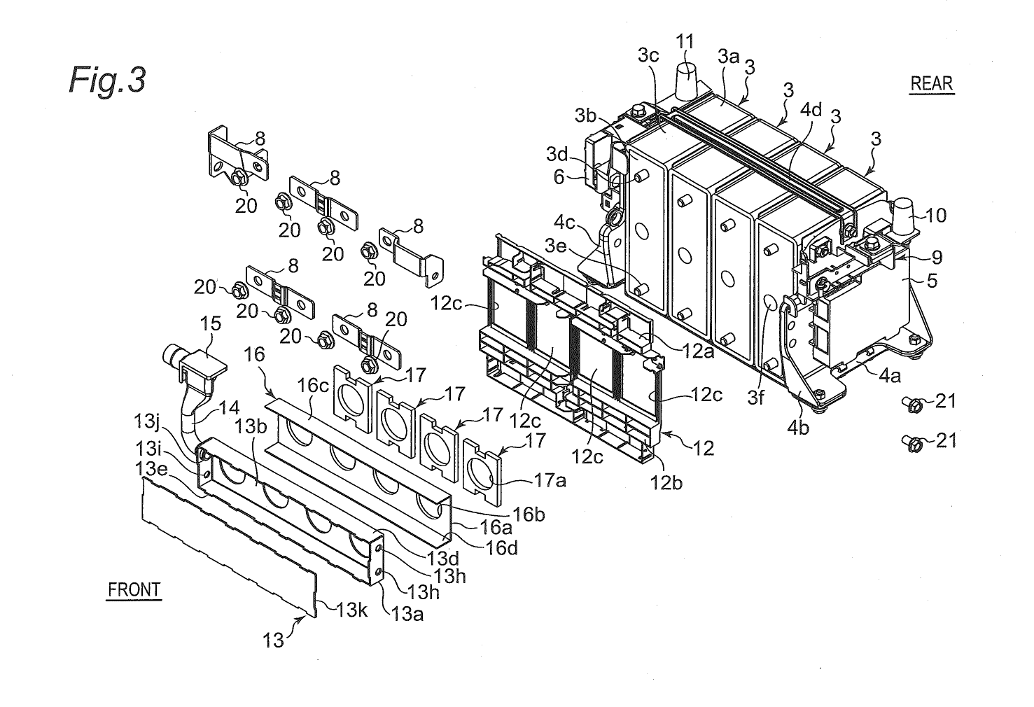

FIGS. 1 to 3 show an in-vehicle assembled battery 1 according to an embodiment of the present invention. To facilitate understanding of the invention, elements unrelated to the invention are omitted from the drawings as much as possible.

The assembled battery 1 includes an outer case 2 made of resin (shown only in FIG. 1). The outer case 2 includes a body 2a and a lid 2b fixed to the body 2a by means of screws. Plural electric cells 3 (four in the embodiment) and a support structure 4 (made of metal in this embodiment) for the electric cells 3 are accommodated in the outer case 2.

The electric cell 3 includes a casing 3c comprises a container 3a whose one end is opened and a lid 3b which closes the opening of the container 3a. An electrode body is accommodated in the casing 3c and the casing 3c is filled with electrolytic solution. A pair of terminals 3d and 3e projects from one side of the casing 3c, more specifically, from longitudinal both ends of the lid 3b. One of the terminals 3d and 3e is a positive terminal and the other one is a negative terminal. In this embodiment, each of the terminals 3d and 3e has a short columnar shape, and a male thread is formed on an outer periphery thereof. A gas exhaust valve (gas exhaust portion) 3f which opens when an internal pressure reaches equal to or more than a predetermined pressure is provided in the vicinity of a longitudinal central portion of the lid 3b (near an intermediate position between terminals 3d and 3e).

The four electric cells 3 are held by the support structure 4 in a state where these electric cells 3 are aligned with such a posture that a longitudinal direction of the lids 3b becomes a vertical direction. The lids 3b of all of the electric cells 3 are oriented in the same direction (front side in the drawings), and the terminals 3d and 3e are aligned in an arrangement direction of the electric cells 3.

The support structure 4 includes a bottom plate 4a on which the electric cells 3 are mounted, and a pair of side plates 4b and 4c fixed to both ends of the bottom plate 4a by means of bolts. The aligned electric cells 3 are held between the side plates 4b and 4c. Upper ends of the side plates 4b and 4c are connected to each other through a connecting beam 4d, and rear sides of the side plates 4b and 4c in the drawings are connected to each other through another connecting beam (not shown). A control unit 5 including a CPU is mounted on the side plate 4b, and a relay unit 6 is mounted on the side plate 4c. The control unit 5 and the relay unit 6 are electrically connected to the electric cells 3 through harnesses (not shown).

The terminals 3d and 3e of the electric cell 3 are electrically connected to the terminals 3d and 3e of the adjacent electric cell 3 through bus bars 8 using nuts 20. The upper terminal 3d of the rightmost electric cell 3 as viewed from front in the drawings is electrically connected to a negative terminal portion 10 of the entire assembled battery through a bus bar group 9. The upper terminal 3d of the leftmost electric cell 3 as viewed from front in the drawings is electrically connected to a positive terminal portion 11 of the entire assembled battery through a bus bar group (not shown). The negative and positive pole terminals 10 and 11 penetrate the lid 2b and project outside of the outer case 2.

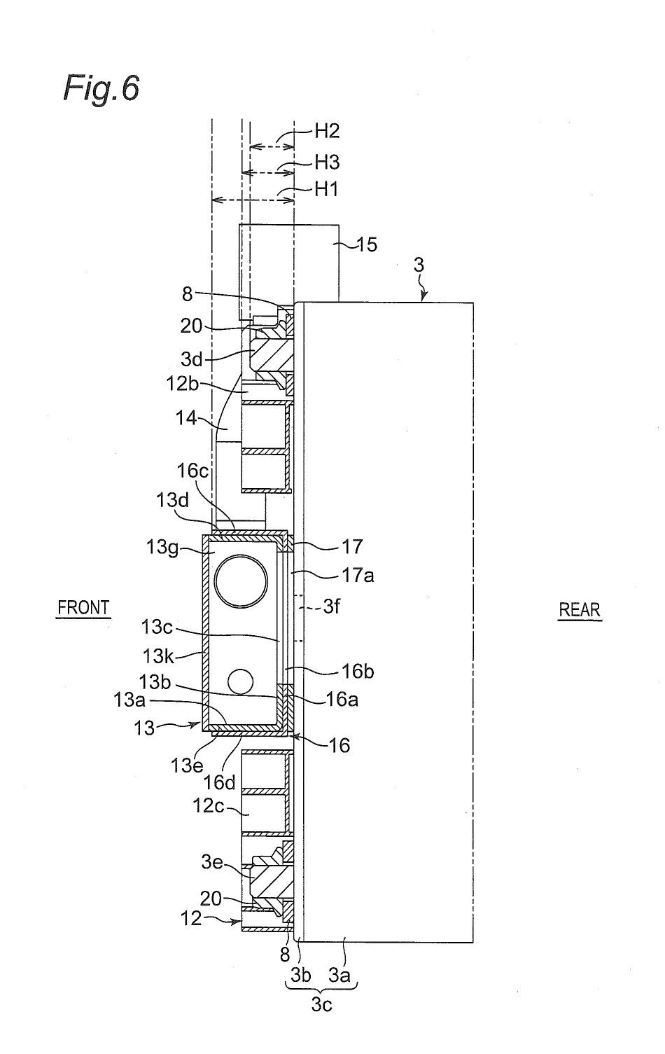

A frame member 12 made of resin as an example of material with insulation property is disposed on a front side (on a side of lid 3b) in the drawing of the aligned electric cells 3. The frame member 12 is disposed on the lids 3b of the electric cells 3 before the bus bars 8 are connected to the terminals 3d and 3e, and thereby the frame member 12 is held on the lids 3b by the bus bars 8. The terminals 3d and 3e of the electric cells 3 penetrate the frame member 12 and project forward in the drawings. As most clearly shown in FIG. 6, the frame member 12 includes surrounding walls 12a and 12b which surround the terminals 3d and 3e by means of plural ribs.

An exhaust duct 13 (covered member) made of metal in the embodiment is mounted on a front side in the drawings of the support structure 4. The exhaust duct 13 has a function to discharge ejected gas to outside when the gas exhaust valve 3f opens and gas is ejected from the casing 3c of the electric cell 3. Since a temperature of gas ejected from the electric cell 3 is high in some cases, it is preferable that the exhaust duct 13 has high heat resistance. If the exhaust duct 13 is made of resin, there is a possibility that the exhaust duct 13 is chemically affected by gas ejected from the electric cell 3. From these aspects, the exhaust duct 13 is preferably made of metal as in this embodiment. The gas ejected from the gas exhaust valve 3f flows from gas inlets 13c into the exhaust duct 13, and then flows toward a gas outlet 13j provided in a left end of the exhaust duct 13 as viewed from front in the drawings. One end of a connecting pipe 14 is connected to the gas outlet 13j, whereas the other end of the connecting pipe 12 is connected to a connector 15. The connector 15 penetrates the lid 2b, projects outside of the outer case 2, and is connected to a downstream flow passage (not shown). A duct cover (insulation cover) 16 made of resin as one example of material with insulation property is attached to the exhaust duct 13.

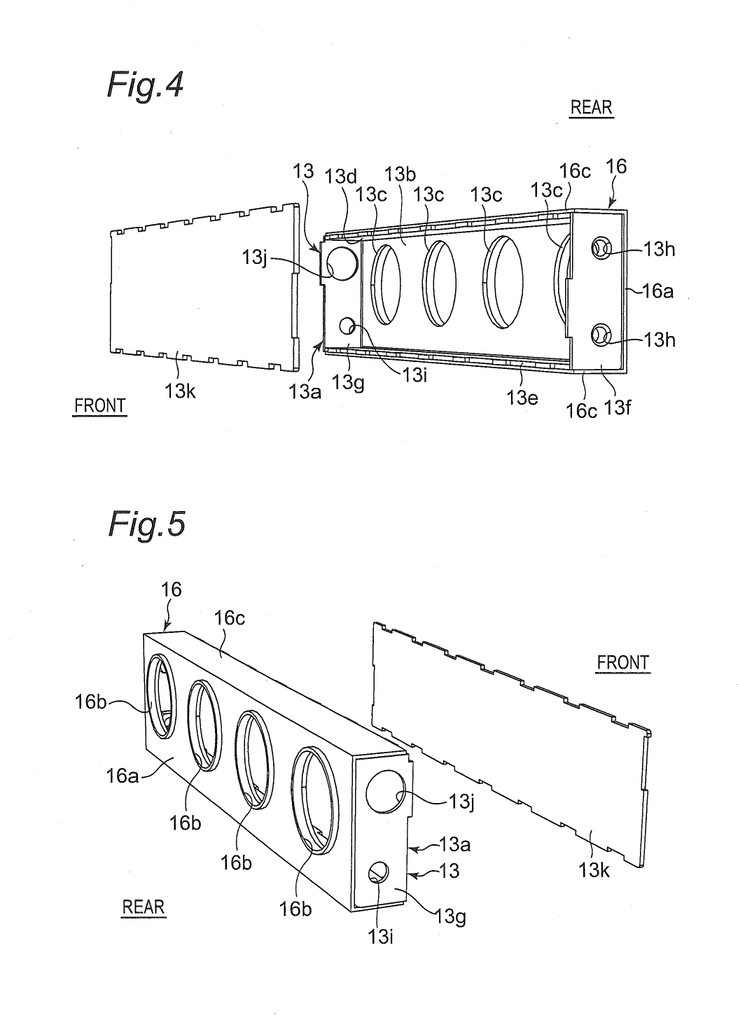

With also reference to FIGS. 4 and 6 also, the exhaust duct 13, the duct cover 16, and their peripheral structure will be described.

The exhaust duct 13 in this embodiment has a hollow box shape with a rectangular cross section, is elongated in a lateral direction in the drawings as a whole, has closed both ends. The exhaust duct 13 is disposed to pass across the lids 3b of the aligned four electric cells 3 in the lateral direction in the drawings. A position of the exhaust duct 13 in a height direction (position in vertical direction) is set at an intermediate position between the pair of terminals 3d and 3e of the electric cell 3 so that the exhaust duct 13 is opposed to the gas exhaust valves 3f of all of the electric cells 3 in a front/rear direction in the drawings.

A duct body 13a of the exhaust duct 13 includes a rectangular main side plate portion 13b opposed to the lids 3b of the electric cells 3. The four gas inlets 13c with circular configurations in the embodiment penetrate the main side plate portion 13b at positions respectively corresponding to the gas exhaust valves 3f of the electric cells 3.

A rectangular top plate portion 13d extending in a direction away from the electric cell 3 is provided along an upper end edge of the main side plate portion 13b. A rectangular bottom plate portion 13e extending in a direction away from the electric cell 3 is provided along a lower end edge of the main side plate portion 13b. End plate portions 13f and 13g are provided on both left and right ends of the duct body 13a in the drawings. Two bolt holes 13h into which bolts 21 are inserted are formed in the end plate portion 13f for coupling the end plate portion 13f to the side plate 4b of the support structure 4. One bolt hole 13i is formed in the side plate portion 13g for coupling the side plate portion 13g to the side plate 4b of the support structure 4, and the above-mentioned gas outlet 13j is formed in an upper portion of the side plate portion 13g in the drawings. A closing plate portion 13k is attached to tip ends of the main side plate portion 13b and the bottom plate portion 13e of the duct body 13a.

The duct cover 16 includes a rectangular plate-shaped main portion 16a which is arranged so as to be superposed on the main side plate portion 13b of the duct body 13a. Four gas-passing holes 16b with circular configuration in the embodiment are formed in the main portion 16a so as to penetrate the main portion 16a in its thickness direction. The gas-passing holes 16b are formed at positions corresponding to the gas inlets 13c of the main side plate portion 13b.

Gaskets 17 are interposed between the main portion 16a of the duct cover 16 and the lids 3b of the electric cells 3 at positions corresponding to the gas exhaust valves 3f of the electric cells 3. Each of the gaskets 17 is formed with a gas-passing hole 17a with circular configuration in the embodiment. Four opening portions 12c are formed in the frame member 12 so as to penetrate the frame member 12 in its thickness direction, and the gaskets 17 are disposed in the opening portions 12c.

As most clearly shown in FIG. 6, a rear surface of the gasket 17 in the drawings is tightly contacted with the lid 3b of the electric cell 3 so that the gas-passing hole 17a enclose the gas exhaust valve 3f. A rear surface of the main portion 16a of the duct cover 16 in the drawings is tightly contacted with a front surface of the gasket 17 in the drawings. A rear surface of the main side plate portion 13b of the duct body 13a in the drawings is tightly contacted with a front surface of the main portion 16a of the duct cover 16 in the drawings. These arrangements form hermetical flow paths which reach the gas inlets 13c of the exhaust duct 13 from the gas exhaust valves 3f through the gas-passing holes 17a of the gaskets 17 and the gas-passing holes 16b of the duct cover 16.

A rectangular upper auxiliary portion 16c extending in a direction away from the electric cell 3 is provided along an upper end edge of the main portion 16a of the duct cover 16. A rectangular lower auxiliary portion 16d extending in a direction away from the electric cell 3 is provided along a lower end edge of the main portion 16a. The upper auxiliary portion 16c is arranged so as to be superposed on the top plate portion 13d of the duct body 13a, whereas the lower auxiliary portion 16d is arranged so as to be superposed on the bottom plate portion 13e of the duct body 13a.

As most clearly shown in FIG. 6, the upper auxiliary portion 16c of the duct cover 16 extending along a projecting direction of the terminal 3d (forward in drawings) is interposed between the terminal 3d of the electric cell 3 and the exhaust duct 13. The lower auxiliary portion 16d of the duct cover 16 extending along the projecting direction of the terminal 3e is interposed between the terminal 3e of the electric cell 3 and the exhaust duct 13. The upper and lower auxiliary portions 16c and 16d of the duct cover 16 extending along the projecting directions of the terminals 3d and 3e of the electric cell 3 can reliably prevent the exhaust duct 13 from coming into contact with the terminals 3d and 3e of the electric cell 3, resulting in reliable prevention of short circuit between the terminals 3d and 3e of the electric cell 3 which may be caused by the contact between the exhaust duct 13 and the terminals 3d and 3e.

Even when the exhaust duct 13 moves in the vertical direction in the drawings so as to approach the terminals 3d and 3e due to vibration or impact, since the upper and lower auxiliary portions 16c and 16d of the duct cover 16 are interposed between the exhaust duct 13 and the terminals 3d and 3e, exhaust duct 13 can be prevented from coming into contact with the terminals 3d and 3e. Further, even if damage or breakage of the assembled battery 1 causes the bus bar 8 to be disengaged from the terminals 3d and 3e so as to approach the exhaust duct 13, the upper or lower auxiliary portion 16c or 16d of the duct cover 16 is interposed between the exhaust duct 13 and the disengaged bus bar 8. The interposition of the upper or lower auxiliary portion 16c or 16d prevents the disengaged bus bar 8 from coming into contact with the exhaust duct 13.

As shown in FIG. 6, a height H1 from the lid 3b of the electric cell 3 to tip ends of the upper and lower auxiliary portions 16c and 16d of the duct cover 16 is set equal to or higher than a height H2 from the lid 3b of the electric cell 3 to tip ends of the terminals 3d and 3e. By setting the heights H1 of the upper and lower auxiliary portions 16c and 16d of the duct cover 16 sufficiently high with respect to the heights H2 of the terminals 3d and 3e, it is possible to reliably avoid the contact and short circuit between the exhaust duct 13 and the terminals 3d and 3e of the electric cell 3 which may be caused when the exhaust duct 13 moves due to damage of breakage.

The surrounding walls 12a and 12b of the frame member 12 are respectively interposed between the terminals 3d and 3e of the electric cell 3 and the upper and lower auxiliary portions 16c and 16d of the duct cover 16. Also because not only the upper and lower auxiliary portions 16c and 16d of the duct cover 16 but also the surrounding walls 12a and 12b of the frame member 12 are interposed between the exhaust duct 13 and the terminals 3d and 3e, the exhaust duct 13 can be prevented from coming into contact with the terminals 3d and 3e of the electric cell 3 when the exhaust duct 13 moves due to damage or breakage.

Especially as shown in FIG. 6, a height H3 from the lid 3b of the electric cell 3 to tip ends of the surrounding walls 12a and 12b of the duct cover 16 is set equal to or higher than the height H2 from the lid 3b of the electric cell 3 to the tip ends of the terminals 3d and 3e. Also by setting the height H3 of the surrounding walls 12a and 12b sufficiently high with respect to the height H2 of the terminals 3d and 3e, it is possible to enhance the contact-preventing effect between the exhaust duct 13 and the terminals 3d and 3e of the electric cell 3.

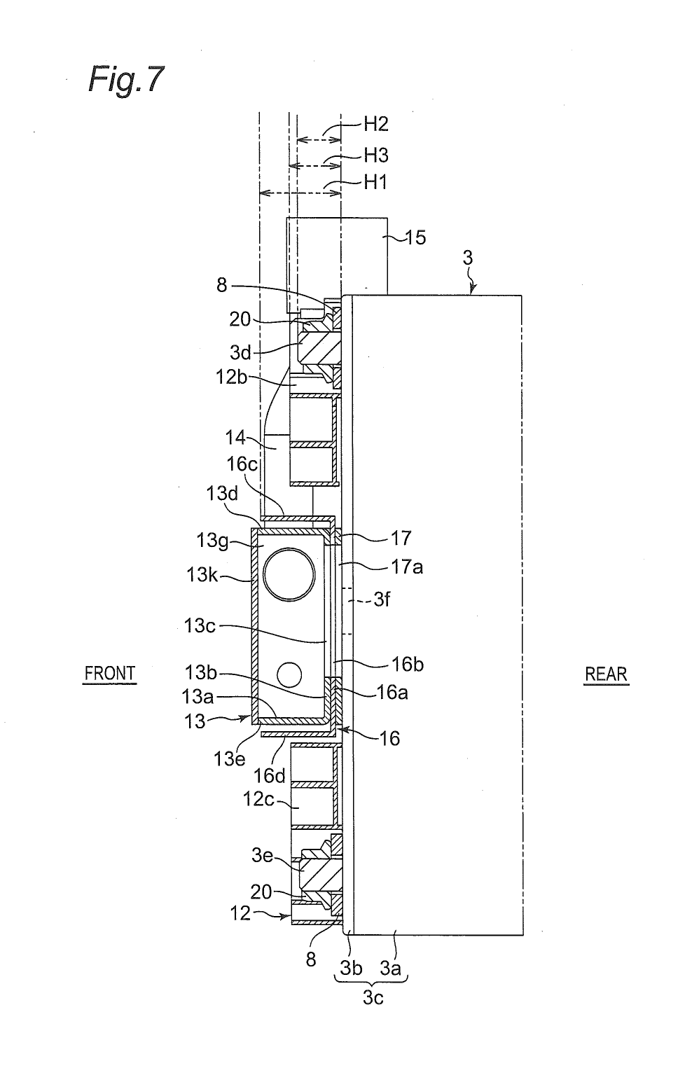

FIG. 7 shows a modification of the upper and lower auxiliary portions 16c and 16d of the duct cover 16. In this modification, the upper auxiliary portion 16c is upwardly located in the drawing at a distance from the top plate portion 13d of the duct body 13a of the duct cover 16. The lower auxiliary portion 16d is downwardly located in the drawing at a distance from the bottom plate portion 13e of the duct body 13a. Even when the upper and lower auxiliary portions 16c and 16d of the duct cover 16 are located at distances from the exhaust duct 13, a contact-preventing function between the exhaust duct 13 and the terminals 3d and 3e of the electric cell 3 can be obtained.

The present invention is not limited to the embodiment and the invention can variously be modified. Although the invention has been described while taking the in-vehicle assembled battery 1 as an example, the invention can also be applied to an assembled battery other than the in-vehicle assembled battery. The invention has been described in the embodiment while taking the combination of the metal-made exhaust duct and the duct cover as an example. However, the invention can also be applied to a combination of a member (at least a portion thereof is made of metal) disposed with respect to electric cells with the same posture and at the same positions as those of the exhaust duct of the embodiment and an insulation cover for that member. Such members (covered member) include, e.g., a metal beam member for connecting a pair of side plates (end plates) configuring a casing of an assembled battery. Further, the insulation cover (duct cover in the embodiment) may be made of material with insulation property such as insulating resin. The insulation duct may be configured by a member made of conductive material such as a metal member may coated with material with insulation property.

What is claimed is:

1. An assembled battery, comprising:
plural electric cells;
a covered member disposed along side portions of the electric cells on which terminals of the electric cells are provided, at least a portion of the covered member being made of metal; and
an insulation cover including a main portion interposed between the covered member and the side portions of the electric cells and an auxiliary portion extending from the main portion along a projecting direction of the terminal.

2. The assembled battery according to claim 1, wherein the plural electric cells are arranged with such postures that the side portions of the electric cells on which the terminals are provided extend in a vertical direction, and
wherein the covered member and the insulation cover are disposed so as to extend in an arranged direction of the electric cells along the side portions of the electric cells.

3. The assembled battery according to claim 2, wherein positions of the covered member and the insulation cover in a vertical direction are set at an intermediate position of a pair of the terminals of each of the electric cells.

4. The assembled battery according to claim 1, wherein a height of the auxiliary portion of the insulation cover with respect to the side portion of the electric cell is equal to or higher than a height of the terminal with respect to the side portion of the electric cell.

5. The assembled battery according to claim 1, further comprising a frame member which is interposed between the side portions of the electric cells and the insulation cover and which includes a surrounding wall surrounding the terminal.

6. The assembled battery according to claim 5, wherein a height of the surrounding wall of the frame member with respect to the side portion of the electric cell is equal to or higher than a height of the terminal with respect to the side portion of the electric cell.

7. The assembled battery according to claim 1, wherein the insulation cover is made of material with insulation property.

8. The assembled battery according to claim 1, wherein the covered member is an exhaust duct through which gas discharged from the electric cell is conducted outside.

9. The assembled battery according to claim 8, wherein the electric cells respectively include gas exhaust portions provided in the side portions on which the terminals are provided, the gas exhaust portions opening when an internal pressure reaches equal to or more than a predetermined value so as to discharge gas,
wherein the exhaust duct includes gas inlets provided at positions opposed to the gas exhaust portions of the electric cells, and wherein a seal member for air-tightly connecting the gas exhaust portion and the gas inlet is interposed between the exhaust duct and the electric cell.
